(19) United States
(12) Patent Application Publication
(10) Pub. No.: US 2012/0156533 A1
(43) Pub. Date: Jun. 21, 2012

(54) Air valve for energy storage device and energy storage device including the same

(75) Inventors: Yeongsu Cho, Gyeonggi-do (KR); Hyunchul Jung, Gyeonggi-do (KR); Baekyun Kim, Gyeonggi-do (KR)

(73) Assignee: SAMSUNG ELECTRO-MECHANICS CO., LTD., Suwon (KR)

(21) Appl. No.: 13/137,221

(22) Filed: Jul. 28, 2011

(30) Foreign Application Priority Data
Dec. 20, 2010 (KR) 10-2010-0130506

(51) Int. Cl. F16K 1/00; H01M 2/12; H01G 9/12

(52) U.S. Cl. 429/56; 361/502; 251/324

(57) ABSTRACT

Disclosed herein are an air valve for an energy storage device and an energy storage device including the same. The air valve for an energy storage device includes: a body including a gas inlet and a gas outlet disposed to be spaced from each other; and a piston included in an inner portion of the body and blocking or opening a path between the gas inlet and the gas outlet, wherein when pressure in the inner portion of the energy storage device increases due to gas generation therein, the piston moves to open the path between the gas inlet and the gas outlet, and when the pressure in the inner portion of the energy storage device decreases due to discharge of the gas in the inner portion of the energy storage device or reduction in the gas generation, the piston moves to block the path between the gas inlet and the gas outlet.

### CROSS REFERENCE(S) TO RELATED APPLICATIONS

This application claims the benefit under 35 U.S.C. Section 119 of Korean Patent Application Serial No. 10-2010-0130506, entitled “Air Valve For Energy Storage Device and Energy Storage Device Including The Same” filed on Dec. 20, 2010, which is hereby incorporated by reference in its entirety into this application.

### BACKGROUND OF THE INVENTION

1. Technical Field

The present invention relates to an air valve for an energy storage device and an energy storage device including the same.

2. Description of the Related Art

In accordance with the recent technology development in a telecommunication field, various mobile electronic products have been released, and an energy storage device such as a secondary battery, etc., has been widely used.

Further, in accordance with increase in interest in an environment problem and a resource problem, competition for developing environment-friendly energy production related technology an automobile, solar power generation, or the like, using an environment-friendly energy has been intensively conducted.

Since the secondary battery maintains its output at a constant voltage for a relatively long time and may have a compact size and a light weight, it may have been already widely used as a power storage device of a small mobile apparatus.

Meanwhile, the secondary battery has disadvantages such as relatively long charging/discharging time, a low output voltage of about 3 V, short lifespan, risk of explosion, thereby having a limitation in application fields.

As an energy storage device capable of supplementing the disadvantages of the secondary battery, the interest in a supercapacitor in which a charging and discharging operation is performed by an electrochemical mechanism has been increased.

There are various kinds of supercapacitors such as an electric double layer capacitor (EDLC), a hybrid capacitor, a pseudo capacitor, or the like. The supercapacitor has advantages such as instantaneous charging, output characteristics significantly higher than that of the secondary battery, and lifespan significantly longer than that of the secondary battery.

In consideration of the above-mentioned advantages, research into the supercapacitor for using for regenerative braking of an automobile, etc., has been continuously conducted.

Meanwhile, the energy storage devices such as the secondary battery, the supercapacitor, and the like, includes an electrolyte solution (or an electrolyte) between electrodes, and has a charging and discharging process performed by the electrochemical mechanism. When the charging and discharging process is performed, various gases may be generated. In the case in which these gases are not appropriately discharged, a case of the energy storage device is broken such that it may be no longer used or may be exploded in a serious case.

Since problems such as energy density, resistance, and the like, have been not completely solved up to now, the supercapacitor has been not smoothly commercialized; however, the supercapacitor will be commercialized in the near future. Therefore, the need to solve reliability deterioration and lifespan reduction problems due to the above-mentioned gas generation has been increased.

FIG. 1 shows a configuration of a valve according to Korean Patent Application No. 2003-47556 proposed in order to solve the above-mentioned problems.

Referring to FIG. 1, in the case of an air valve disclosed in the patent application, when gas is generated in an inner portion of the energy storage device such that pressure is increased, the gas is discharged, while a metal thin film 1 is broken. In the case of using this scheme, whenever the metal thin film 1 is broken, it should be replaced with a new metal thin film.

### SUMMARY OF THE INVENTION

An object of the present invention is to provide an air valve for an energy storage device capable of being semi-permanently used, while maintaining internal pressure of the energy storage device in a predetermined range, and an energy storage device including the same.

According to an exemplary embodiment of the present invention, there is provided an air valve for an energy storage device for discharging gas generated in an inner portion of the energy storage device, the air valve including: a body including a gas inlet and a gas outlet disposed to be spaced from each other; and a piston included in an inner portion of the body and blocking or opening a path between the gas inlet and the gas outlet, wherein when pressure in the inner portion of the energy storage device increases due to gas generation therein, the piston moves to open the path between the gas inlet and the gas outlet, and when the pressure in the inner portion of the energy storage device decreases due to discharge of the gas therein or reduction in the gas generation, the piston moves to block the path between the gas inlet and the gas outlet.

According to another exemplary embodiment of the present invention, there is provided an air valve for an energy storage device for discharging gas generated in an inner portion of the energy storage device, the air valve including: a body including a gas inlet formed in a bottom surface thereof and a gas outlet formed in a side thereof; and a piston included in an inner portion of the body and vertically moving according to pressure of the gas introduced into the gas inlet in a state of contacting the side of the body.

The air valve may further include a guide formed on an upper surface of the piston, the guide guiding the piston so that piston moves in a vertical direction; and a hole for the guide formed in a top surface of the body, wherein the guide is configured to be inserted into the hole for the guide.

The air valve may further include an elastic member formed between an upper surface of the piston and a top inner side of the body.

The gas outlet may be formed in the side of the body to be spaced apart by ½ or less of a body height from the bottom surface of the body.

At least one of a material and a thickness of the body may be the same as that of a case of the energy storage device.

According to another exemplary embodiment of the present invention, there is provided an energy storage device including an air valve for an energy storage device as described above.

### BRIEF DESCRIPTION OF THE DRAWINGS

FIG. 1 is a cross-sectional view showing a configuration of an air valve according to the related art.

FIG. 2 is a cross-sectional view showing a configuration of an air valve for an energy storage device according to an exemplary embodiment of the present invention.

FIG. 3 is a cross-sectional view showing a configuration of an air valve for an energy storage device according to another exemplary embodiment of the present invention; and.

FIG. 4 is a cross-sectional view showing a configuration of an air valve for an energy storage device according to another exemplary embodiment of the present invention.

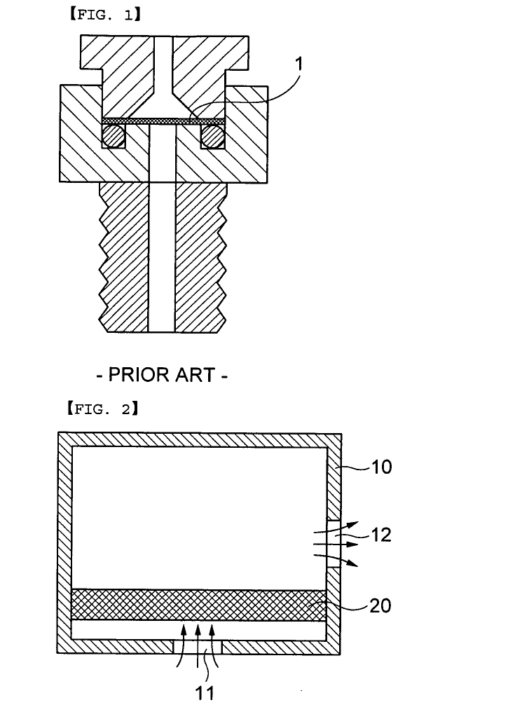

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and operation of the present invention will be described in detail with reference to the accompanying drawings.

FIG. 2 is a cross-sectional view showing a configuration of an air valve for an energy storage device according to an exemplary embodiment of the present invention.

Referring to FIG. 2, an air valve for an energy storage device according to an exemplary embodiment of the present invention may be configured to include a body 10 and a piston 20.

The body 10 includes a gas inlet 11 and a gas outlet 12.

The gas inlet 11 is formed inside a case of the energy storage device so that gas generated in an inner portion of the energy storage device may be introduced therein.

The gas outlet 12 should be formed so that it may be blocked from the gas inlet 11 based on the piston 20.

Although FIG. 2 shows a case in which the gas inlet 11 is formed in a bottom surface of the body 10 and the gas outlet 12 is formed in a side of the body 10, the present invention is not limited thereto.

The piston 20 serves to block or open a path between the gas inlet 11 and the gas outlet 12, while moving in an inner portion of the body 10.

In this configuration, an O-ring is preferably provided on a contact surface between the piston 20 and the body 10 to close them so that the gas is not leaked.

Referring to FIG. 2, the piston 20 blocks and opens the path between the gas inlet 11 and the gas outlet 12, while vertically moving in a state in which a side part thereof contacts a side inner portion of the body 10.

That is, when a great quantity of gas is accumulated such that internal pressure of the energy storage device increase to a predetermine level or more, the piston 20 rises. As a result, when the piston 20 rises to be higher than the gas outlet 12, the gas in the inner portion of the body 10 is discharged to the outside through the gas outlet 12.

Meanwhile, when the gas is discharged as described above, force pushing the piston 20 upwardly is weakened, such that the piston 20 falls. When the piston 20 falls to be lower than the gas outlet 12, the gas in the inner portion of the body 10 is no longer discharged and the inner portion of the energy storage device is closed.

In addition, when the gas outlet 12 formed in the side of the body 10 is disposed as closely to the bottom surface of the body having the gas inlet 11 formed therein as possible, the gas may be smoothly discharged. Therefore, the gas outlet 12 is preferably formed in the side of the body to be spaced apart by ½ or less of a body height from the bottom surface of the body.

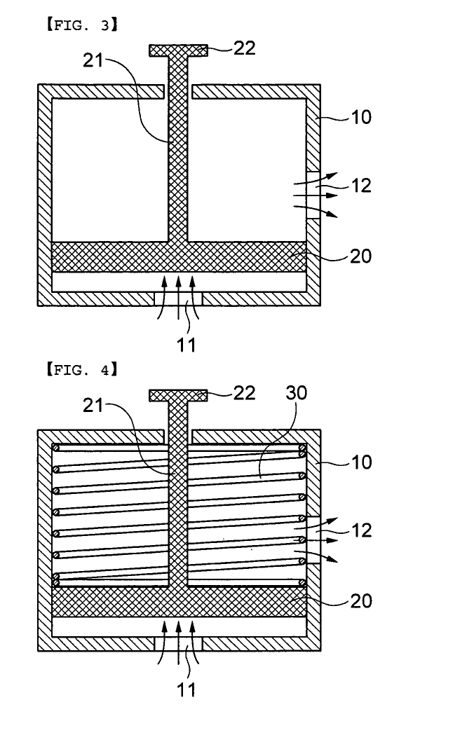

FIG. 3 is a cross-sectional view showing a configuration of an air valve for an energy storage device according to another exemplary embodiment of the present invention.

Referring to FIG. 3, an air valve for an energy storage device according to another exemplary embodiment of the present invention may further include a guide 21 formed on an upper surface of the piston 20 and a blocking bar 22 formed on an upper end of the guide 21.

The piston 20 may rise, while not maintaining level due to causes such as non-uniform distribution of pressure of the gas introduced in the gas inlet 11, non-uniform distribution of friction force between the piston 20 and the body 10, and the like. When the piston 20 does not maintain level as described above, a gap is generated between the piston 20 and the body 10, such that air-tightness in the inner portion of the energy storage device is not maintained.

The guide 21, which is to solve the problem, contacts a hole for the guide 21 formed in a top surface of the body 10, and perform a function so that the piston 20 may serve to rise or fall, while maintaining level.

Meanwhile, the guide 21 has a short length such that when an end of the guide 21 is inserted into the inner portion of the body 10, the end of the guide 21 may be caught by the inner wall of the body 10. As a result, the piston 20 does not rise, such that even in the case in which the gas in the inner portion of the energy storage device exceeds a predetermined pressure, the gas is not discharged to the outside. The blocking bar 22 serves to prevent the above-mentioned problem.

Other configuration is the same as described with reference to FIG. 2; and a description of overlapping portions will thus be omitted.

FIG. 4 is a cross-sectional view showing a configuration of an air valve for an energy storage device according to another exemplary embodiment of the present invention.

Referring to FIG. 4, an air valve for an energy storage device according to another exemplary embodiment of the present invention may further include an elastic member 30 formed between the upper surface of the piston and a top inner side of the body 10.

Meanwhile, although FIG. 4 shows an example in which the elastic member 30 is formed in a state in which the guide 21 and the blocking bar 22 are provided, the elastic member 30 may be formed without the guide 21 and the blocking bar 22.

Threshold pressure is changed according to characteristics such as a size of the energy storage device, a kind of electrode and electrolyte solution, capacity, internal pressure of the case of the energy storage device, and the like. In order to precisely control gas discharging time according to various threshold pressures, it is necessary to precisely control a rising condition of the piston 20.

The air valve for an energy storage device according to another exemplary embodiment of the present invention includes the elastic member 30, thereby making it possible to precisely control the rising condition of the piston 20.

In this case, the elastic member 30 may be formed of a spring, or the like.

In addition, weight of the piston, elastic force of the elastic member, friction force between the piston and the body, and the like, may be controlled so that the gas may be discharged under an appropriate pressure condition in consideration of the internal pressure of the energy storage device.

In this case, the body may be made of various materials such as a metal, a non-metal, or the like. The case of the energy storage device and the body is configured to be made of the same material and/or have the same thickness, thereby making it possible to more precisely set the above-mentioned gas discharging condition.

The present invention configured as described above may appropriately solve increase in the internal pressure due to the gas generated in the inner portion of the energy storage device, thereby making it possible to improve reliability of the energy storage device and lengthen lifespan thereof.

In addition, the air valve for an energy storage device according to the exemplary embodiment of the present invention may be repetitively used without a consumable component, unlike the air valve for an energy storage device according to the related art.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

1. An air valve for an energy storage device for discharging gas generated in an inner portion of the energy storage device, the air valve comprising:
a body including a gas inlet and a gas outlet disposed to be spaced from each other; and
a piston included in an inner portion of the body and blocking or opening a path between the gas inlet and the gas outlet,
wherein when pressure in the inner portion of the energy storage device increases due to gas generation therein, the piston moves to open the path between the gas inlet and the gas outlet, and
when the pressure in the inner portion of the energy storage device decreases due to discharge of the gas therein or reduction in the gas generation, the piston moves to block the path between the gas inlet and the gas outlet.

2. An air valve for an energy storage device for discharging gas generated in an inner portion of the energy storage device, the air valve comprising:
a body including a gas inlet formed in a bottom surface thereof and a gas outlet formed in a side thereof; and
a piston included in an inner portion of the body and vertically moving according to pressure of the gas introduced into the gas inlet in a state of contacting the side of the body.

3. The air valve according to claim 2, further comprising:
a guide formed on an upper surface of the piston, the guide guiding the piston so that the piston moves in a vertical direction; and
a hole for the guide formed in a top surface of the body,
wherein the guide is configured to be inserted into the hole for the guide.

4. The air valve according to claim 2, further comprising an elastic member formed between an upper surface of the piston and an upper inner side of the body.

5. The air valve according to claim 2, wherein the gas outlet is formed in the side of the body to be spaced apart by ½ or less of a body height from the bottom surface of the body.

6. The air valve according to claim 2, wherein at least one of a material and a thickness of the body is the same as that of a case of the energy storage device.

7. An energy storage device comprising an air valve for an energy storage device according to claim 1.

8. An energy storage device comprising an air valve for an energy storage device according to claim 2.

9. An energy storage device comprising an air valve for an energy storage device according to claim 3.

10. An energy storage device comprising an air valve for an energy storage device according to claim 4.

11. An energy storage device comprising an air valve for an energy storage device according to claim 5.

12. An energy storage device comprising an air valve for an energy storage device according to claim 6.
